(19) United States
(12) Patent Application Publication
(10) Pub. No.: US 2014/0139304 A1
(43) Pub. Date: May 22, 2014

(54) Self-Healing Corrosion Protection Coatings for Nd-Fe-B Magnets

(71) Applicant: GM GLOBAL TECHNOLOGY OPERATIONS LLC, Detroit, MI (US)

(72) Inventor: Yar-Ming WANG, Rochester Hills, MI (US)

(73) Assignee: GM GLOBAL TECHNOLOGY OPERATIONS LLC, Detroit, MI (US)

(21) Appl. No.: 13/681,724

(22) Filed: Nov. 20, 2012

(51) Int. Cl. H01F 1/01; C23F 17/00

(52) U.S. Cl. CPC H01F 1/01; C23F 17/00
USPC 335/302; 205/188; 205/190

(57) ABSTRACT

A neodymium magnet (Nd—Fe—B) is protected by a self-healing, corrosion-resistant coating of (a) a sacrificial metal layer; (b) optionally, a metal pretreatment layer on the sacrificial metal layer; and (c) an electrocoat coating layer.

### FIELD

The present disclosure relates to Nd—Fe—B magnets such as are used in automotive motors.

### BACKGROUND

This section provides information helpful in understanding the invention but that is not necessarily prior art.

Neodymium magnets (Nd—Fe—B) are the permanent magnets most often used in automotive motors due to their excellent magnetic properties. These magnet, however, have been highly susceptible to corrosion in the humid and salty environments encountered in automotive vehicles during use.

### SUMMARY

This section provides a general summary of the disclosure and is not comprehensive of its full scope or all of the disclosed features.

A neodymium magnet (Nd—Fe—B) is protected by a self-healing, corrosion-resistant coating having at least a sacrificial metal layer on the surface of the neodymium magnet and a layer of an electrocoat coating on the sacrificial metal layer. A sacrificial metal is a metal with a higher electrode potential than iron so that it acts as the anode in a galvanic cell with the neodymium magnet. In particular embodiments, the sacrificial metal layer may be an aluminum layer, a zinc layer, or magnesium layer, or a layer of an alloy of one or more of these metals.

Also disclosed is a neodymium magnet (Nd—Fe—B) protected by a self-healing, corrosion-resistant three-layer coating of (a) a sacrificial metal layer on the surface of the neodymium magnet, (b) a metal pretreatment layer such as a phosphate coating layer on the sacrificial metal layer, and (c) an electrocoat coating layer on the phosphate layer.

As used in this specification, singular forms may include the plural forms as well, unless the context clearly indicates otherwise (e.g., “a” as used includes embodiments with one as well as more than one). The terms “comprises,” “comprising,” “including,” and “having” are inclusive and therefore specify the presence of stated features, or steps, but do not preclude additional features or steps. The method steps may not necessarily be performed in the particular order discussed or illustrated, unless specifically identified or required as an order of performance. When used, “or” includes embodiments of each element listed used separately or in any combination with one or more other listed elements. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

### DRAWINGS

The drawings described herein are for illustrative purposes only of selected embodiments and not all possible implementations, and are not intended to limit the scope of the present disclosure.

FIG. 1 is a cross-sectional view of one embodiment of the invention and

FIG. 2 illustrates a protective property of the embodiment of FIG. 1.

Corresponding reference numerals indicate corresponding parts throughout the several views of the drawings.

### DETAILED DESCRIPTION

A detailed description of exemplary, nonlimiting embodiments follows.

Neodymium magnets are known and described in the literature, for example, in Sagawa et al., U.S. Pat. No. 4,770,723 and Katsunori et al., U.S. Pat. No. 4,960,469, both of which are incorporated herein by reference. As an example embodiment, a representative sintered neodymium magnet has a multi-phase skeleton-like microstructure consisting of the following phases: a ferromagnetic phase 4), Nd₂Fe₁₄B (85% by volume); a boron-rich phase η, NdFe₄B₄ (3% by volume); and a neodymium-rich phase n, NdFe (12% by volume). The neodymium-rich and boron-rich phases are embedded in the ferromagnetic phase φ (Nd₂Fe₁₄B). This structure ensures good magnetic properties. However, if the neodymium magnet is not protected as now disclosed, it also promotes selective attack on the Nd-rich phase present in the grain boundary of the phase φ, which may cause grains of the boron-rich and neodymium-rich phases to fall away from the magnet as they are undermined by corrosion of the ferromagnetic phase. The coating layers now disclosed protect the neodymium magnet from such corrosion and thereby extend the useful life of the neodymium magnet.

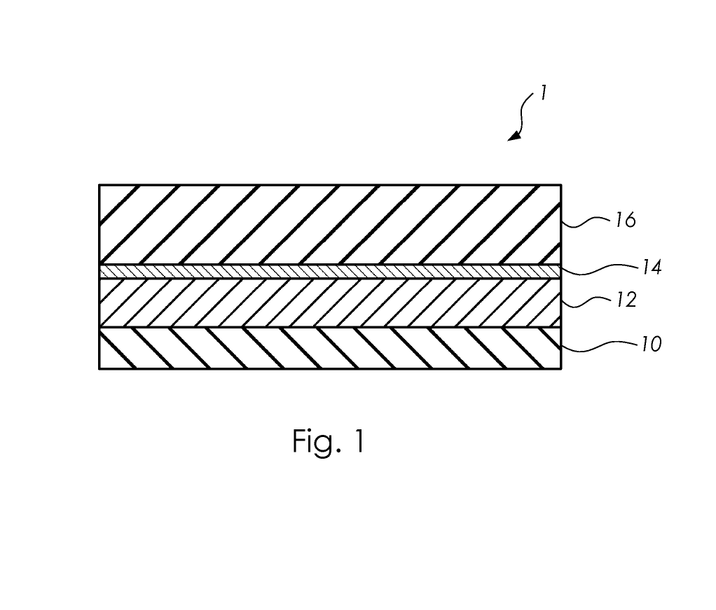

FIG. 1 is a cross-sectional view of a coated neodymium magnet 1 showing a neodymium magnet 10 having a sacrificial metal layer 12 on its surface. The sacrificial metal layer is a metal with a higher electrode potential than iron so that it acts as the anode in a galvanic cell with the neodymium magnet. In particular embodiments, the sacrificial metal layer may comprise aluminum, zinc, magnesium, combinations of aluminum, zinc, and magnesium, or alloys of one or more of aluminum, zinc, and magnesium. In various preferred embodiments, sacrificial metal layer may be an aluminum layer, a zinc layer, or a magnesium layer, or a layer of an alloy of one or more of these metals, and in particular the sacrificial metal layer may be or include aluminum, combinations of aluminum with one or both of zinc and magnesium, and aluminum alloys. In certain embodiments, the sacrificial metal layer may be from about 2 to about 20 micrometers thick, preferably from about 5 to about 10 micrometers thick, and more preferably from about 5 or 6 or 7 to about 8 or 9 or 10 micrometers thick. In other embodiments, the sacrificial metal layer may be from about 1 or 2 or 3 or 4 or 5 or 6 or 7 to about 8 or 9 or 10 or 11 or 12 or 13 or 14 or 15 or 16 or 17 or 18 or 19 or 20 micrometers thick. The sacrificial metal layer may be applied to the neodymium magnet by any method known for applying metal layers, including the well-known methods of physical vapor deposition, electroless plating, electroplating, and cladding.

The sacrificial metal layer-coated neodymium magnet may then be provided with a metal pretreatment layer such as a phosphate conversion coating layer 14. Many electrocoat coating compositions need to have a metal pretreatment layer such as a phosphate coating layer to achieve good adhesion of the electrocoat coating to the sacrificial metal layer. When such an electrocoat coating is used, the metal pretreatment layer may be any of those known to be useful for this purpose.

The neodymium magnet 10 having a sacrificial metal layer 12 may first be cleaned to remove grease, dirt, or other extraneous matter. Such a cleaning step is usually done by employing conventional cleaning procedures and materials such as, example, mild or strong alkali cleaners, acidic cleaners, and the like, such as sodium metasilicate and sodium hydroxide. Such cleaners may be preceded by a water rinse and are generally followed by a water rinse.

The metal pretreatment can be a non-insulating layer of organophosphates or organophosphonates such as those described in U.S. Pat. Nos. 5,294,265 and 5,306,526. Such a phosphate coating may preferably be a zinc phosphate coating, although other phosphate coatings are known and may be used. In various embodiments, zinc phosphate coating compositions are acidic and contain zinc ion and phosphate ion, as well as, additional ions, such as manganese ion, depending upon the particular conversion coating composition selected,

In certain embodiments, a zinc ion content of aqueous acidic compositions may be from about 0.5 to 1.5 g/1 and may preferably be about 0.8 to 1.2 while the phosphate content is preferably between about 8 to (and may more preferably be about 12 to 14 g/l. The source of the zinc ion may be conventional zinc ion sources, such as zinc nitrate, zinc oxide, zinc carbonate, zinc metal, and the like, while the source of phosphate ion may be phosphoric acid, monosodium phosphate, &sodium phosphate, as nonlimiting examples. An aqueous acidic zinc phosphate composition typically has a pH of about 2.0 to about 5.5 and in certain embodiments is preferably from about 3.5 to about 5.5. The pH of the medium may be adjusted using mineral acids such as hydrofluoric acid, fluoroboric acid, phosphoric acid, and the like, including mixtures thereof; organic acids such as lactic acid, acetic acid, citric acid, sulfamic acid, or mixtures thereof; and water soluble or water dispersible bases such as sodium hydroxide, ammonium hydroxide, ammonia, or amines such as triethylamine, methylethyl amine, or mixtures thereof.

In order to speed up the metal pretreatment coating such as the phosphate coating application to the metal, accelerators may be added to the pretreatment coating composition. A typical accelerator is nitrite ions, provided by the addition of a nitrite ion source such as sodium nitrite, ammonium nitrite, or the like to the zinc phosphate coating composition. Other accelerators have also been proposed for use in conversion coatings such as zinc phosphate coating compositions, including, accelerators such as aromatic nitro compounds, particularly m-nitrobenzenesulfonate oximes, chlorate ion, hydroxylamine ion, and hydrogen peroxide. The concentration of accelerator depends on the specific accelerator used. An aqueous acidic phosphate compositions may contain fluoride ion, nitrate ion, and various metal ions, such as nickel ion, cobalt ion, calcium ion, magnesium ion, manganese ion, iron ion, and the like. When present, fluoride ion may be in an amount of about 0.1 to about 2.5 g/l and preferably about 0.25 to about 1.0 g/l, nitrate ion in an amount of about 1 to about 10 g/l, preferably about 2 to about 5 g/l; nickel ion in an amount of about 0 to about 1.8 g/l, preferably about 0.2 to about 1.2 g/l, and more preferably about 0.3 to about 0.8 g/l; calcium ion in an amount of up to about 4.0 g/l, preferably about 0.2 to about 2.5 g/l; manganese ion in an amount up to about 1.5 g/l, preferably about 0.2 to about 1.5 g/l, and more preferably about 0.8 to about 1.0 g/l; iron ion in an amount of up to about 0.5 g/l, preferably about 0.005 to about 0.3 g/l.

The pretreatment coating composition can further comprise surfactants that function as aids to improve wetting of the substrate. Generally, the surfactant materials are present in an amount of less than about 2 weight percent on a basis of total weight of the pretreatment coating composition. Other optional materials in the carrier medium include defoamers and substrate wetting agents.

The aqueous metal pretreatment or conversion coating compositions may be applied to the sacrificial metal layer 12 by known application techniques, such as dipping, spraying, intermittent spraying, dipping followed by spraying or spraying followed by dipping, immersion or roll coating. In general, the coating may be applied completely and evenly over the surface of the sacrificial metal layer. Typically, the pretreatment or conversion coating composition is applied to the metal substrate at temperatures of about 10° C. to about 85° C., and preferably at temperatures of from of 15° C. to about 60° C. The contact time thr the application of the zinc phosphate coating composition is generally between about 0.5 to about 5 minutes when dipping the neodymium magnet 10 having a sacrificial metal layer 12 in the metal pretreatment coating composition and between about 0.5 to 3.0 minutes when the metal pretreatment composition is sprayed onto the neodymium magnet 10 having a sacrificial metal layer 12.

Application of the phosphate pretreatment is typically is followed by the step of rinsing the substrate with deionized water prior to the coalescing of the coating. This ensures that the layer of the non-conductive coating is sufficiently thin to be non-insulating, i.e., sufficiently thin such that the non-conductive coating does not interfere with electroconductivity of the substrate, allowing application of an electrodepositable coating composition.

After the pretreatment composition has been applied to the metal surface, the metal can be rinsed with deionized water and dried at room temperature or at elevated temperatures to remove excess moisture from the coated surface and cure any curable coating components to form the pretreatment coating. Alternatively, the treated substrate can be heated to a temperature ranging from 65° C. to 125° C. for 2 to 30 seconds to produce a coated substrate having a layer of dried residue of the pretreatment coating composition. The temperature and time for drying the coating will depend upon such variables as the percentage of solids in the coating and components of the coating composition. The film coverage of the residue of the pretreatment composition generally ranges from 1 to 10,000 and usually from 10 to 400 milligrams per square meter.

Further examples and details may be found in the literature, including those described in U.S. Pat. Nos. 5,294,265 and 5,306,526. Phosphate coatings are available commercially from many sources, for example from Henkel Corporation, Rocky Hill, Conn., Chemetall Americas, New Providence, N.J., and PPG Industries, Inc., Euclid Ohio (under the trade name NUPAL®).

The thickness of the metal pretreatment layer can vary, but may be from about 1 to about 2 micrometers, for example.

The neodymium magnet 10 having a sacrificial metal layer 12 and metal pretreatment layer 14 is then coated with an electrocoat coating composition (also called an electrodeposition coating composition) to form electrocoat layer 16. Electrocoat baths usually comprise an aqueous dispersion or emulsion including a principal film-forming epoxy resin having ionic stabilization in water or a mixture of water and organic cosolvent. The electrocoat compositions are formulated to be curable (thermosetting) compositions for durability. This is usually accomplished by emulsifying with the principal film-forming resin a crosslinking agent that can react with functional groups on the principal resin under appropriate conditions, such as with the application of heat, and so cure the coating. During electrodeposition, coating material containing the ionically-charged resin is deposited onto a conductive substrate by submerging the substrate in the electrocoat bath and then applying an electrical potential between the substrate and a pole of opposite charge, for example, a stainless steel electrode. The charged coating material migrates to and deposits on the conductive substrate, which in this case is the neodymium magnet with the sacrificial metal layer and optional pretreatment (e.g., phosphate) layer. The coated substrate is then heated to cure or crosslink the electrocoat coating.

The electrocoat coating composition can be any of the anionic or cationic electrodepositable coating compositions well known in the art. Electrocoat coating compositions usually comprise a resinous phase dispersed in an aqueous medium, the resinous phase comprising (a) an active hydrogen group-containing ionic resin and (b) a curing agent having functional groups reactive with the active hydrogen groups of the ionic resin.

Examples of film-forming resins suitable for use in anionic electrodeposition bath compositions are base-solubilized, carboxylic acid containing polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are at least partially neutralized interpolymers of hydroxy-alkyl esters of unsaturated carboxylic acids, unsaturated carboxylic acid and at least one other ethylenically unsaturated monomer. Still another suitable electrodepositable resin comprises an alkyd-aminoplast vehicle, i.e., a vehicle containing an alkyd resin and an amine-aldehyde resin. Yet another anionic electrodepositable resin composition comprises mixed esters of a resinous polyol. Further details of such compositions may be found, for example, in U.S. Pat. No. 3,749,657, incorporated herein by reference. Other acid-functional polymers can also be used such as phosphatized polyepoxide or phosphatized acrylic polymers as are well-known in the art.

Cationic polymers suitable for use in the electrocoat coating compositions can include any of a number of cationic polymers well known in the art. Such polymers comprise cationic functional groups to impart a positive charge. Suitable examples of cationic film-forming resins include amine salt group-containing resins such as the acid-solubilized reaction products of polyepoxides and primary or secondary amines such as those described in U.S. Pats. No. 3,663,389; 3,984,299; 3,947,338; and 3,947,339, all of which are incorporated herein by reference. Usually, these amine salt group-containing resins are used in combination with a blocked polyisocyanate curing agent. The polyisocyanate can be fully blocked as described in U.S. Pat. No. 3,984,299 or the polyisocyanate can be partially blocked and reacted with the resin backbone such as described in U.S. Pat. No. 3,947,338. Also, one-component compositions as described in U.S. Pat. No. 4,134,866 and DE-OS No. 2,707,405, which are incorporated herein by reference, can be used as the film-forming resin. Besides the epoxy-amine reaction products, film-forming resins can also be selected from cationic acrylic resins such as those described in U.S. Pats. No. 3,455,806 and 3,928,157, which are incorporated herein by reference.

Besides amine salt group-containing resins, quaternary ammonium salt group-containing resins can also be employed. Examples of these resins are those which are formed from reacting an organic polyepoxide with a tertiary amine salt. Such resins are described in U.S. Pats. No. 3,962,165; 3,975,346; and 4,001,101, all of which are incorporated herein by reference. Examples of other cationic resins are ternary sulfonium salt group-containing resins and quaternary phosphonium salt-group containing resins such as those described in U.S. Pats. No. 3,793,278 and 3,984,922, respectively, which are incorporated herein by reference. Also, film-forming resins which cure via transesterification such as described in European Application No. 12463, incorporated herein by reference, can be used. Further, cationic compositions prepared from Mannich bases such as described in U.S. Pat. No. 4,134,932, incorporated herein by reference, can be used.

Most often, the resin (a) is a positively charged resin which contains primary and/or secondary amine groups. Such resins are described in U.S. Pats. No. 3,663,389; 3,947,339 and 4,116,900, all of which are incorporated herein by reference. In U.S. Pat. No. 3,947,339, a polyketimine derivative of a polyamine such as diethylenetriamine or triethylenetetraamine is reacted with a polyepoxide. When the reaction product is neutralized with acid and dispersed in water, free primary amine groups are generated. Also, equivalent products are formed when polyepoxide is reacted with excess polyamines such as diethylenetriamine and triethylenetetraamine and the excess polyamine vacuum stripped from the reaction mixture. Such products are described in U.S. Pats. No. 3,663,389 and 4,116,900.

Electrocoat coating compositions containing certain principal film-forming resins may not require a metal pretreatment layer 14 to achieve good adhesion of the electrocoat coating to the sacrificial metal layer, for example those disclosed in U.S. Pat. Application Publications No. 2010/0167089, 2010/0167088, 2010/0167072, 2010/0167071, 2010/0167070, 201/0167069, 2010/0167062, 2010/0166973, 2010/0163424, 2010/0163423, 2010/0163418, and 2010/0163417, all of which are incorporated herein by reference. When such electrocoat coating compositions are used, they may be applied directly to the sacrificial metal layer.

The active hydrogen-containing, ionic electrodepositable resin can be present in the electrodeposition baths in amounts ranging from 1 to 60 percent by weight, often from 5 to 25 percent by weight based on total weight of the electrodeposition bath.

The curing agent reactive with the active hydrogen groups of the ionic electrodepositable resin is often a blocked polyisocyanate or aminoplast curing agent.

Aminoplast resins, typically used as the curing agent for anionic electrodeposition, are the condensation products of amines or amides with aldehydes. Examples of suitable amine or amides are melamine, benzoguanamine, urea and similar compounds. Generally, the aldehyde employed is formaldehyde, although products can be made from other aldehydes such as acetaldehyde and furfural. The condensation products contain methylol groups or similar alkylol groups depending on the particular aldehyde employed. Preferably, these methylol groups are etherified by reaction with an alcohol. Various alcohols employed include monohydric alcohols containing from 1 to 4 carbon atoms such as methanol, ethanol, isopropanol, and n-butanol, with methanol being preferred.

The aminoplast curing agents typically are used in amounts ranging from about 5 percent to about 60 percent by weight, preferably from about 20 percent to about 40 percent by weight, the percentages based on the total weight of the resin solids in the electrodeposition bath.

Typically, curing agents for use in cathodic electrodeposition include blocked polyisocyanates. The polyisocyanates can be fully blocked as described in U.S. Pat. No. 3,984,299 or partially blocked and reacted with the polymer backbone as described in U.S. Pat. No. 3,947,338, which are incorporated by reference herein. By “blocked” is meant that the isocyanate groups have been reacted with a compound so that the resultant blocked isocyanate group is stable to active hydrogens at ambient temperature but reactive with active hydrogens in the film forming polymer at elevated temperatures usually between 90° C. and 200° C.

Suitable polyisocyanates include aromatic and aliphatic polyisocyanates, including cycloaliphatic polyisocyanates and representative examples are diphenylmethane-4,4′-diisocyanate (MDI), 2,4- or 2,6-toluene diisocyanate (TDI), mixtures of these, p-phenylene diisocyanate, tetramethylene and hexamethylene diisocyanates, dicyclohexylmethane-4,4′-diisocyanate, isophorone diisocyanate, mixtures of phenylmethane-4,4′-diisocyanate and polymethylene polyphenylisocyanate. Higher polyisocyanates such as triisocyanates can be used, for example, triphenyl methane-4,4′,4″-triisocyanate. Suitable polyisocyantes also include polyisocyanates derived from these that containing isocyanurate, biuret, allophanate, iminooxadiazinedione, urethane, urea, or uretdione groups. Polyisocyanates containing urethane groups, for example, are obtained by reacting some of the isocyanate groups with polyols, such as trimethylolpropane, neopentyl glycol, and glycerol, for example. The isocyanate groups are reacted with a blocking agent. Examples of suitable blocking agents include phenol, cresol, xylenol, epsilon-caprolactam, delta-valerolactam, gamma-butyrolactam, diethyl malonate, dimethyl malonate, ethyl acetoacetate, methyl acetoacetate, alcohols such as methanol, ethanol, isopropanol, propanol, isobutanol, tert-butanol, butanol, glycol monoethers such as ethylene or propylene glycol monoethers, acid amides (e.g. acetoanilide), imides (e.g. succinimide), amines (e.g. diphenylamine), imidazole, urea, ethylene urea, 2-oxazolidone, ethylene imine, oximes (e.g. methylethyl ketoxime), and the like.

The polyisocyanate curing agents typically can be utilized in conjunction with the active hydrogen containing cationic electrodepositable resin in amounts ranging from 5 percent to 60 percent by weight, and typically from 20 percent to 50 percent by weight, the percentages based on the total weight of the resin solids of the electrodeposition bath.

The aqueous electrodepositable electrocoat coating compositions are in the form of an aqueous dispersion. The term “dispersion” is believed to be a two-phase transparent, translucent or opaque resinous system in which the resin is in the dispersed phase and the water is in the continuous phase. The average particle size of the resinous phase is generally less than 1.0 and usually less than 0.5 microns, preferably less than 0.15 micron.

The concentration of the resinous phase in the aqueous medium is at least 1 and usually from 2 to 60 percent by weight based on total weight of the aqueous dispersion. When the compositions of the present invention are in the form of resin concentrates, they generally have a resin solids content ranging from 20 to 60 percent by weight based on weight of the aqueous dispersion.

The active hydrogen-containing, terminal amino group-containing polymer is rendered cationic and water dispersible by at least partial neutralization with an acid. Suitable acids include organic and inorganic acids such as formic acid, acetic acid, lactic acid, phosphoric acid, dimethylolpropionic acid, and sulfamic acid. Mixtures of acids can be used. The extent of neutralization varies with the particular reaction product involved. However, sufficient acid should be used to disperse the electrodepositable composition in water. Typically, the amount of acid used provides at least 30 percent of the total theoretical neutralization. Excess acid may also be used beyond the amount required for 100 percent total theoretical neutralization.

The extent of cationic salt group formation should be such that when the polymer is mixed with an aqueous medium and the other ingredients, a stable dispersion of the electrodepositable composition will form. By “stable dispersion” is meant one that does not settle or is easily redispersible if some settling occurs. Moreover, the dispersion should be of sufficient cationic character that the dispersed particles will migrate toward and electrodeposit on a cathode when an electrical potential is set up between an anode and a cathode immersed in the aqueous dispersion. Generally, the cationic polymer is uncrosslinked and contains from about 0.1 to 3.0, preferably from about 0.1 to 0.7 millequivalents of cationic salt group per gram of polymer solids.

The active hydrogens associated with the cationic polymer include any active hydrogens which are reactive with isocyanates within the temperature range of about 93° C. to 204° C., preferably about 121° C. to 177° C. Typically, the active hydrogens are selected from the group consisting of hydroxyl and primary and secondary amino, including mixed groups such as hydroxyl and primary amino. Preferably, the polymer will have an active hydrogen content of about 1.7 to 10 millequivalents, more preferably about 2.0 to 5 millequivalents of active hydrogen per gram of polymer solids.

The electrocoat coating compositions may further comprise other optional ingredients. Besides water, the aqueous medium may contain a coalescing solvent, for example, hydrocarbons, alcohols, esters, ethers and ketones, such as isopropanol, butanol, 2-ethylhexanol, isophorone, 2-methoxypentanone, ethylene and propylene glycol and the monoethyl, monobutyl and monohexyl ethers of ethylene glycol. Pigment and, if desired, various additives such as surfactants, wetting agents or catalysts also can be included in the dispersion. Other ingredients can include corrosion inhibitive materials, for example, rare earth metal compounds such as soluble, insoluble, organic and inorganic salts of rare earth metals such as yttrium, bismuth, zirconium, and tungsten.

The electrocoating step can include immersing the neodymium magnet 10 having a sacrificial metal layer 12 and metal pretreatment layer 14 into an electrocoat bath of an aqueous electrodepositable composition, the magnet being connected as a cathode in an electrical circuit that also comprises an anode in the electrocoat bath. Sufficient electrical current is applied between the electrodes to deposit a substantially continuous, adherent film of the electrocoat coating onto the pretreatment layer 14. Electrodeposition is usually carried out at a constant voltage in the range of from 1 volt to several thousand volts, typically between 50 and 500 volts, and more usually between 150 and 400 volts. Current density is usually between 1.0 ampere and 15 amperes per square foot (10.8 to 161.5 amperes per square meter) and tends to decrease quickly during the electrocoat process, indicating formation of a continuous, self-insulating film.

Once the electrocoat coating composition is applied, the electrocoat coating layer 16 is typically heated to a temperature and for a time sufficient to cure the electrocoat coating layer. The coating can be heated to a temperature of from 250° to 450° F. (121.1° to 232.2° C.), often from 250° to 400° F. (121.1° to 204.4° C.), and typically from 300° to 360° F. (148.9° to 180° C.). The curing time can be dependent upon the curing temperature as well as other variables, for example, film thickness of the electrocoat coating layer, amount and type of catalyst present in the composition, and crosslinking chemistry. For example, the curing time can range from 10 minutes to 60 minutes, and typically may be from 10 to 30 minutes. The electrocoat coating is preferably fully cured for optimum physical properties, particularly for optimum protection of the coated neodymium magnet. The thickness of the cured electrocoat coating layer usually ranges from 5 or 10 to 15 or 20 or 30 or 50 micrometers.

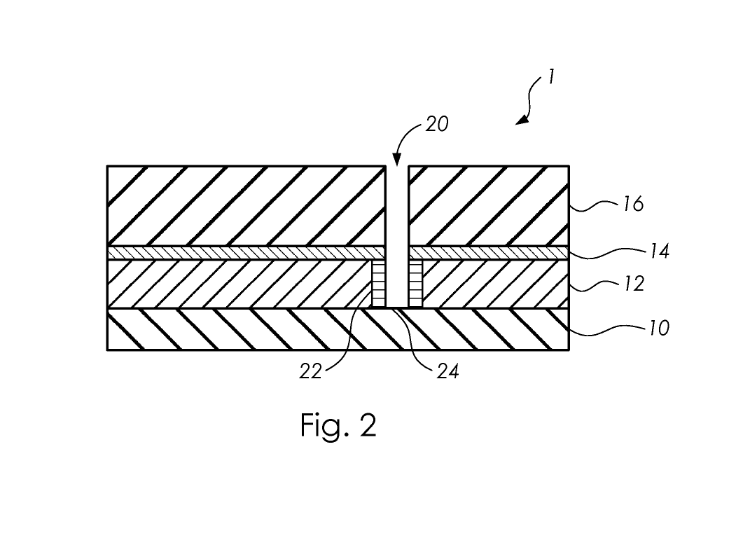

FIG. 2 illustrates the self-healing property of the coating (layers 12 and 16 or layers 12, 14, and 16) of the neodymium magnet 10, in particular for an aluminum sacrificial metal layer 12. When the multi-layer coating is damaged by scratches or microcracks such as scratch or crack 20, which extends through all coating layers to the surface of neodymium magnet 10, the exposed aluminum-neodymium magnet corrosion couple has a mixed potential between the corrosion potentials of aluminum and the neodymium magnet. The mixed potential lies in the passive potential region of aluminum so that the corroded aluminum surface 22 is passivated, stopping corrosion and cathodically protecting the neodymium magnet surface 24.

The description is merely exemplary in nature and, thus, variations that do not depart from the gist of the disclosure are a part of the invention. Variations are not to be regarded as a departure from the spirit and scope of the disclosure.

What is claimed is:

1. A method of protecting a neodymium magnet, comprising
(a) applying a sacrificial metal layer;
(b) optionally, applying a metal pretreatment layer onto the sacrificial metal layer; and
(c) applying an electrocoat coating layer.

2. A method according to claim 1, wherein the sacrificial metal layer comprises a member selected from the group consisting of:
aluminum, zinc, magnesium,
combinations thereof, and
aluminum, zinc, and magnesium alloys.

3. A method according to claim 2, wherein the sacrificial metal layer comprises a member selected from the group consisting of:
aluminum, combinations of aluminum with one or both of zinc and magnesium, and aluminum alloys.

4. A method according to claim 1, further comprising curing or crosslinking the applied electrocoat coating layer.

5. A method according to claim 4, wherein the electrocoat coating layer is applied from a composition comprising an acid-solubilized reaction product of polyepoxide and primary or secondary amine and a blocked polyisocyanate curing agent.

6. A method according to claim 1, wherein the metal pretreatment layer is applied onto the sacrificial metal layer and the metal pretreatment layer comprises a phosphate.

7. A method according to claim 1, wherein the electrocoat coating layer is applied directly to the sacrificial metal layer.

8. A neodymium magnet, comprising a coating comprising:
(a) a sacrificial metal layer;
(b) optionally, a metal pretreatment layer on the sacrificial metal layer; and
(c) an electrocoat coating layer.

9. A neodymium magnet according to claim 8, wherein the sacrificial metal layer comprises a member selected from the group consisting of:
aluminum, zinc, magnesium,
combinations thereof, and
aluminum, zinc, and magnesium alloys.

10. A neodymium magnet according to claim 9, wherein the sacrificial metal layer comprises a member selected from the group consisting of:
aluminum, combinations of aluminum with one or both of zinc and magnesium, and aluminum alloys.

11. A neodymium magnet according to claim 8, further comprising curing or crosslinking the applied electrocoat coating layer.

12. A neodymium magnet according to claim 11, wherein the electrocoat coating layer is a crosslinked reaction product of a primary or secondary amine-functional polyepoxide and a polyisocyanate curing agent.

13. A neodymium magnet according to claim 8, comprising a metal pretreatment layer comprising a phosphate.

14. A neodymium magnet according to claim 8, wherein the electrocoat coating layer is directly on the sacrificial metal layer.
